(19) United States
(12) Patent Application Publication
(10) Pub. No.: US 2013/0019101 A1
(43) Pub. Date: Jan. 17, 2013

(54) METHOD FOR CONFIGURING AND DISTRIBUTING ACCESS RIGHTS IN A DISTRIBUTED SYSTEM

(71) Applicants: Sven MOHR, Mannheim (DE); Uwe BERKES, Dudenhofen (DE)

(72) Inventors: Sven MOHR, Mannheim (DE); Uwe BERKES, Dudenhofen (DE)

(73) Assignee: ABB TECHNOLOGY AG, Zurich (CH)

(21) Appl. No.: 13/621,416

(22) Filed: Sep. 17, 2012

Related U.S. Application Data
(63) Continuation of application No. PCT/EP2011/001156, filed on Mar. 9, 2011.

(30) Foreign Application Priority Data
Mar. 17, 2010 (EP) 10002790.3
Sep. 24, 2010 (EP) 10010505.5

(51) Int. Cl. H04L 9/32

(52) U.S. Cl. 713/172

(57) ABSTRACT

The disclosure relates to a method and system for configuring and distributing access rights among intelligent devices within a distributed system. The distributed system includes a first intelligent device connected to further intelligent devices. Device-internal individual keys and a shared key are stored in the intelligent devices. A user account is created in the first device via a web client and is encrypted by the device-internal key of the first device and stored as a password file in the first device. Before being transmitted via the web client, the password file is encrypted by the shared key and the encrypted password file is transmitted to the further intelligent devices. The data stored in the encrypted password file are decrypted by the shared key. An encrypted storage of the password file is carried out by the device-internal key of the respective device.

### RELATED APPLICATION(S)

This application claims priority as a continuation application under 35 U.S.C. §120 to PCT/EP2011/001156, which was filed as an International Application on Mar. 9, 2011 designating the U.S., and which claims priority to European Application 10002790.3 filed in Europe on Mar. 17, 2010 and European Application 10010505.5 filed in Europe on Sep. 24, 2010. The entire contents of these applications are hereby incorporated by reference in their entireties.

### FIELD

The disclosure relates to a method for configuring and distributing access rights for intelligent electronic devices disposed in a distributed system. The disclosure furthermore relates to a device to carry out the method. The disclosure can be used in network control and station automation systems which can be used, for example, in utility supply systems which are used for the transmission and/or distribution of for example electricity, gas, water, oil or district heating but can also be suitable for self-contained industrial installations.

### BACKGROUND INFORMATION

Intelligent Electronic Devices (IED) can be microprocessor-based devices which can be used, for example, in remotely monitored distributed systems. These devices can include, inter alia, remote control substations, also known as Remote Terminal Units (RTU), protective devices and also intelligent switching devices and voltage regulators in medium-voltage and high-voltage installations.

In the known network control systems, the network control centre can be connected to the Remote Terminal Units via a communications link. The process data provided by a process controller or system controller are transmitted, for example, in real time, from physically mutually remote parts of a technical installation or of the technical process via the RTUs to the control centre. Not only can alarms relating to dangerous process conditions be generated but also the recording of all events within the distributed system can be processed and supplied to the network control centre by the RTUs.

Access to the data stored in the Remote Terminal Units and/or the operation of these devices can be protected, for example, via a password protection or a user account, wherein the password protection allocated to the respective device can be provided from a user account. The password protection can be configured individually for each device.

The user account can be stored in the Remote Terminal Units (RTU) of the network control system in each case as a file in which the user account can be integrated. The user account can include, inter alia, the name of the authorized user, an allocated password and access rights or the access permission for specific functions such as, for example, the permission to make changes in the configuration of the RTUs. This file can be stored in an encrypted format in a re-writable, non-volatile memory of the RTU so that the RTU user has access to the data recorded by the device or to the operation of the device only after entering a password.

Because the configuration of the user account can be carried out individually on each device, the administration of the access rights for the devices of the distributed system can require a substantial amount of time. Particularly changes relating to the access rights can be time-consuming because the configurations of the access rights are carried out separately for each device affected by the change.

### SUMMARY

A method is disclosed for configuring and distributing access rights among intelligent devices within a remotely monitored, distributed network control and station automation system of a utility supply system, wherein the distributed system includes at least a first intelligent device which is connected to further intelligent devices, via a network connection by a web client, and process and/or installation data provided from physically mutually remote parts of the utility supply system are transmitted to the intelligent devices, the method comprising: storing a device-internal individual key and a shared key in each of the intelligent devices; creating and configuring a user account in the first intelligent device via the web client as a password file, individually encrypting the password file by a device-internal individual key of the first intelligent device and storing the individually encrypted password file in a memory module provided in the first intelligent device; encrypting the password file by the shared key before reading the password file into the web client and making available the encrypted password file via the web client to the further intelligent devices; distributing the encrypted password file by the web client via the network connection among the further intelligent devices; decrypting the data stored in the encrypted password file in the further intelligent devices by the shared key; and carrying out an individually encrypted storage of the password file with the previously decrypted data in a further respective intelligent device by a device-internal individual key of the respective intelligent device.

A device is disclosed for configuring and distributing access rights among intelligent devices within a remotely monitored, distributed network control and station automation system of a utility supply system, process and/or installation data being provided from physically mutual remote parts of the utility supply system, comprising: a first intelligent device; a web client for creating and configuring a user account in the first intelligent device; further intelligent devices connected to the at least one first intelligent device via a network connection of the web client, each of the first intelligent device and the further intelligent devices including a first memory module and a second memory module; a first device-internal individual key stored in the second memory module of the first intelligent device for individually encrypting a password file of a user account, the second memory module storing the individually encrypted password file; a shared key stored in the first memory module of the first intelligent device for encrypting data of the password file prior to reading into the web client, wherein the encrypted password file is distributed to the further intelligent devices via the web client through the network connection, and the shared key is stored in the further intelligent devices for decrypting the data stored in the encrypted password file; and a further device-internal individual key of each respective further intelligent device for individually encrypting a password file containing previously decrypted data prior to its storage in the respective further intelligent device.

### BRIEF DESCRIPTION OF THE DRAWINGS

The disclosure is explained and described in detail with reference to FIGS. 1 and 2, in which:

FIG. 1 shows an example of a procedure for configuring and distributing a user account among intelligent devices within a distributed network control and station automation system of a technical installation according to an exemplary embodiment of the disclosure; and

FIG. 2 shows an exemplary embodiment of a device according to the disclosure using the method according to an exemplary embodiment of the disclosure, which can be used in a distributed, remotely monitored system.

### DETAILED DESCRIPTION

The method according to an exemplary embodiment of the disclosure and the device according to an exemplary embodiment of the disclosure are provided for distributing the user accounts for the access and/or the operation of the devices simultaneously among a multiplicity of the intelligent devices, such as the Remote Terminal Units, of the distributed system.

For configuring and distributing access rights among the intelligent devices disposed within a distributed system of a technical process or a technical installation, for example, a network control system, at least a first intelligent device can be provided which is connected by a web client which can be designed as a user interface, communications service or operating interface via a network connection to further intelligent devices of the distributed system. Process and/or installation data are transmitted, for example, in real time, to the devices of the distributed system from physically mutually remote parts of the technical installation or technical process.

The method according to an exemplary embodiment of the disclosure for configuring and distributing access rights among the intelligent devices of the distributed system includes:

In a preparatory step, a device-internal individual key for encrypted storage of a password file in the device and a shared key, which is understood by the intelligent devices disposed in the distributed system can be stored in each case in the intelligent devices of the distributed system.

In a first step, a user account is created and configured in the first device via the web client, for example, integrated in the first device or interacting with the first device. A separate data processing device, such as, for example, a PC, can be provided as the web client, which is connectable to the intelligent devices of the distributed system by a network connection, for example, a wireless network.

A name of the user, a password and/or access rights, for example, are defined in the user account, with which direct access to the device without authorization is avoided. The user account is encrypted by the individual device-internal key of the first device and is stored as a password file in a memory module provided in the first device, for example, a re-writable, non-volatile memory.

In a second step, the password file having the user account is encrypted, before being read out into the web client by the shared key which is understood by the further intelligent devices disposed in the system, and the password file with the user account now encrypted with the shared key is made available to the web client for transmission to the further intelligent devices.

In a further step, the encrypted password file is distributed by the web client via the network connection among the further intelligent devices disposed in the system. The transmission of the password file between the web client and the intelligent devices within the distributed system can be carried out, for example, by a serial data transmission or via a TCP/IP protocol.

In a final step, the data stored in the encrypted password file previously transmitted by the web client are decrypted by the shared key in the further intelligent devices. An encrypted storage of the password file with the previously encrypted data is then carried out by the device-internal key of the respective device in the respective further intelligent device.

The disclosure therefore can enable the outlay in the administration and distribution of user accounts among a multiplicity of devices of the distributed system to be minimized, because the user account now only needs to be created and configured in a first device and the user account is then distributed among the further intelligent devices disposed in the distributed system without the need for further security-related measures to avoid unauthorized access to the devices.

In an exemplary embodiment of the method according to the disclosure, the user account can be distributed simultaneously via the device-internal web server of the first device only among all further devices disposed in the system and operating as web servers of a device type corresponding to the first device. In this case, the same shared device-specific keys can be stored in each case in the devices of the same device type. In the devices of a different device type, further shared keys corresponding to this device type are stored accordingly.

The device for configuring and distributing access rights among intelligent devices within a distributed system of a technical process or technical installation according to an exemplary embodiment of the disclosure can include at least a first intelligent device which communicates by a web client via a network connection with further intelligent devices and process and/or installation data can be transmitted to the intelligent devices from physically mutually remote parts of the technical installation or technical process.

The intelligent devices in each case have at least a first memory module, for example, a RAM memory, and in each case a second memory module for example, a CF card. The RAM memory can be equipped with an internal data structure for storing the data of a password file.

A shared key readable or understood by the intelligent devices of the distributed system can be stored in each case in the first memory module. A device-internal individual key, which is readable or understood only by the respective device, can be stored in each case in the second memory module.

A user account, which can be provided as a file for storage in the memory module of the first device, is created and configured in the first device by the web client interacting with the first device.

The first device-internal key stored in the first device is provided to encrypt the user account before the user account is stored as a password file in the second memory module.

The shared key stored in the first device is provided to encrypt the data of the password file which are to be distributed among the further intelligent devices disposed in the distributed system before being read into the web client.

After the web client has distributed the password file encrypted by the shared key via the network connection among the further intelligent devices, the shared key stored in the further intelligent devices decrypts the data stored in the encrypted password file.

Before these data are available for storage in the second memory module of the respective further intelligent device, it is provided to encrypt the password file with the previously decrypted data by the device-internal key allocated to the respective device.

With the device according to the disclosure, the file with the configured user account can be securely transmitted by the device-internal web server of the first device via the network connection to the web client, while avoiding unauthorized access, wherein the first device operating as a web server provided to distribute the user account simultaneously via the existing network connection among further intelligent devices disposed in the system.

In an exemplary embodiment of the disclosure, the user account can be distributed via the device-internal web client of the first device among all further devices of a similar device type disposed in the system.

In an exemplary embodiment according to the disclosure, the intelligent devices in each case have at least a second memory module, for example, designed as a Compact Flash memory card (CF card), wherein the second memory module exchanges data with the first memory module in each case via at least one decryption module and at least one encryption module. The respective device-internal key allocated to the device and created in the second memory module can be provided in order to encrypt or decrypt the data transmitted from or to the first memory module.

In an exemplary embodiment according to the disclosure, the intelligent devices in each case have at least a first memory module, for example, designed as a RAM memory, wherein the first memory module exchanges data with the web client, for example, a PC, in each case via at least one further decryption module and at least one further encryption module. The respective shared key is provided in order to encrypt or decrypt the data transmitted from or to the web client.

The encryption module and decryption module are therefore provided to encrypt the file provided by the device and having the user account for transmission to the web client before its transmission, and to decrypt the file, also referred to as the password file, received by the web client and having the user account before its storage in the memory module.

It is shown below by way of example how a change to the access rights or access data is configured on a first device and distributed among the further devices in the system.

After a user account has been created and configured in the first device, i.e., for example, a user name, password and/or access rights have been defined, the user account configured in this way is stored as a password file in the memory module of the first device.

For a change to the access rights, the existing information is overwritten in the password file with new information resulting from the changed access data.

In the user account, the name of the authorized user and the password allocated to the user can be either freely selectable or are subject to predefined rules, which are normally prescribed by a password guideline.

The information allowing access to the user account is encrypted in the password file in the re-writable first memory of the device to prevent access and is stored with the respective device-internal key.

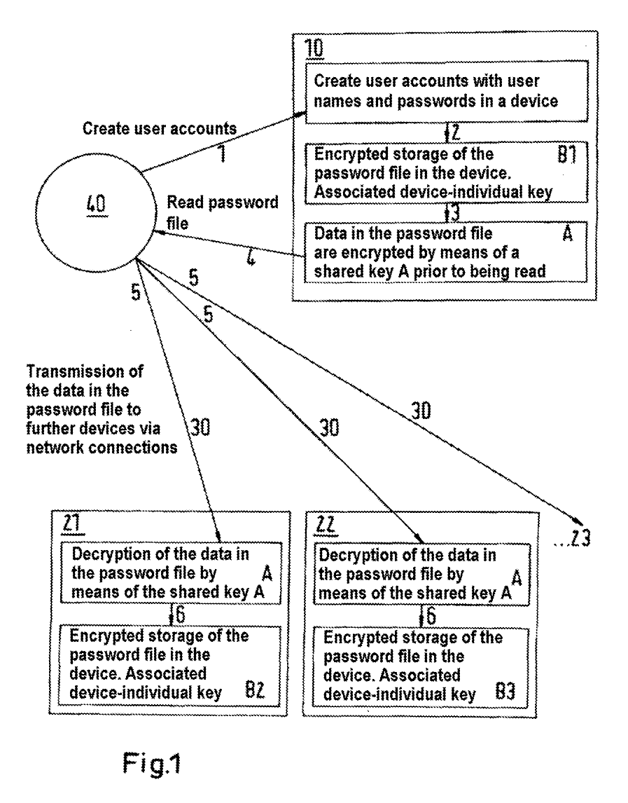

The method shown in FIG. 1 for configuring and distributing a user account among intelligent devices within a distributed network control and station automation system includes a first intelligent device 10, which is connected by means of a web client 40 via a network connection 30 to further intelligent devices 21, 22, 23, . . . . Process and/or installation data are transmitted from physically mutually remote parts of the installation to the intelligent devices 10, 21, 22, 23.

According to the disclosure, device-internal individual keys B1, B2, B3, . . . for the encrypted storage of a password file and a shared key A, which is understood by all intelligent devices 10, 21, 22, 23, are stored in each case in the intelligent devices 10, 21, 22, 23 disposed in the distributed system.

The device-internal keys B1, B2, B3, . . . are stored in a memory module, for example, designed as a Compact Flash memory card (CF card), of the respective device 10, 21, 22, 23.

The shared key A is provided by the firmware installed on the devices 10, 21, 22, 23.

The procedure for configuring and distributing a user account among intelligent devices 10, 21, 22, 23 is presented below.

In a first step 1, a user account with a user name and a password is created and configured in the first device 10 via the web client 40 interacting with the first device 10.

In a second step 2, the user account is encrypted by the individual device-internal key B1 of the first device 10 and is stored as a password file, for example, in the memory module designed as a Compact Flash memory card.

Through the use of the memory module designed as a Compact Flash memory card, which is a memory medium without moving parts in which the information can be permanently stored in the re-writable flash memory, the data of the password file can be securely stored even under unfavorable environmental conditions. Other memory media which can be disposed permanently or directly on the plug-in cards of the device, such as, for example, Secure Digital memory cards (SD card), are also suitable for the storage of the password file in the device.

In a step 3, the password file, before being read into the web client (40), is encrypted by the shared key A, which is known to or understood by the further devices 21, 22, 23, . . . disposed in the system, and the password file now encrypted with the shared key A with the user account can be made available to the web client 40 in a following step 4 for transmission to the further intelligent devices 21, 22, 23, . . . or is read by the latter from the first device 10.

According to the disclosure, in a step 5, the encrypted password file is distributed by the web client via the network connection 30 among further intelligent devices 21, 22, 23, . . . disposed in the system.

In step 6, the data stored in the encrypted password file are decrypted in the further intelligent devices 21, 22, 23 by the shared key A, which is also stored on the further devices 21, 22, 23, . . . of the distributed system, and an encrypted storage of the password file with the previously decrypted data is carried out in the respective further intelligent device 21, 22, 23, . . . by the device-internal keys B1, B2, B3, . . . which are stored in the respective further devices 21, 22, 23.

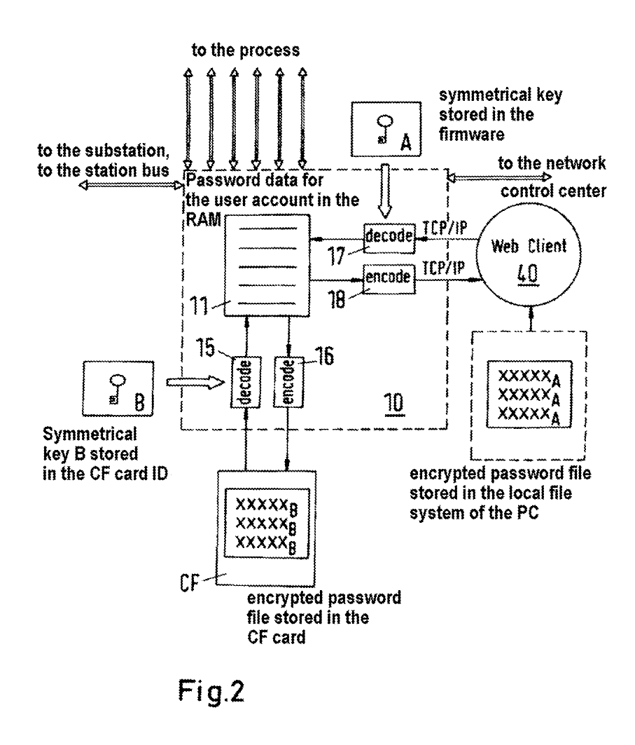

FIG. 2 shows an example of a communications unit of a remote control substation 10, referred to as a Remote Terminal Unit, of a remotely monitored distributed system, which can be disposed on a plug-in card of the RTU and is provided to exchange data with a web client 40 via a network connection 30. The device shown is suitable for carrying out the method according to the disclosure.

The device according to an exemplary embodiment the disclosure for configuring and distributing access rights among the intelligent devices 10, 21, 22, 23 within the remotely monitored distributed system of a technical process or technical installation can include the at least one web client 40 and intelligent devices 10, 21, 22, 23, . . . connected thereto via a network connection 30 and operating as web servers, to which the process or installation data provided from physically mutually remote parts of the technical installation or technical process can be transmitted in real time.

According to the disclosure, a first key A and a further key B are in each case provided for the devices 10, 21, 22, 23 which are configured via the web client 40 with the method described in FIG. 1, wherein the first key A interacts with the web client 40 and the first memory module 11 and the further key B interacts with the first and the second memory module 11, CF.

In the Remote Terminal Unit 10 shown, also referred to below as the first device 10, a user account can be created and configured, and stored as the password file X in a memory module CF of the first device 10. The user account is created by the web client 40, for example a PC, which interacts with the first device 10 in the creation of the user account. The user data, including, for example, the name of the authorized user, an allocated password and access rights or the access permission for specific functions are entered onto the PC 40 and are stored as a password file in an encrypted format in the memory module of the first device 10 designed as a Compact Flash memory card CF. The encryption of the password file X is carried out using a first encryption module 16 by the device-internal key B1 of the first device 10, which can similarly be stored in the Compact Flash memory card CF.

By the device-internal web server of the first device 10, the password file X with the previously configured user account can be transmitted via the network connection 30 to the web client 40, for example, a PC. The web client 40 is provided to distribute the user account via the existing network connection 30 among further intelligent devices 21, 22, 23 disposed in the system and for example, operating as web servers. It can be provided here for the user account to be distributed by the first device 10 via the web client 40 only among all further devices of a similar device type disposed in the system.

Furthermore, at least a second encryption module 18 and at least a second decryption module 17 are in each case integrated into the intelligent devices 21, 22, 23, wherein the second encryption module 18 is provided to encrypt the data provided by the device 10 and having the user account for transmission to the web client 40 before their transmission to the web client 40, and the second decryption module 18 is provided to decrypt the file, also referred to below as the password file, received by the web client 40 and having the user account, before its storage in the RAM memory 11. The shared key A is used for this purpose.

In an exemplary embodiment of the device according to the disclosure shown in FIG. 2, with a first device 10, which is used in the distributed, remotely monitored system, the data X with the user account which have been created and configured by the web client 40 can be stored, for example, as plain text, in the RAM memory 11 acting as a central source. This memory 11 cannot be accessed from outside the device.

The password file of the first device 10 is therefore encoded with the shared, for example, symmetrical, key A before being transmitted to the web client 40 of the distributed system. The key A can be integrated into firmware storable on the device 10. This enables the password file encoded in this way to be transmitted to further devices 21, 22, 23, integrated into the system, in which the same key A is integrated into their firmware. These devices, which are normally of the same device type, can thus be subsequently equipped with the same password file. If a symmetrical key is used, the algorithms for encryption and decryption of the password file are identical.

Furthermore, the shared key B, also configurable as a symmetrical key B and enabling the identification or encoding of the password file on the device 10, for example by an identification number allocated to the flash memory card CF, for example, the serial number of the flash memory card CF, can be provided for the storage of the password file on the flash memory CF of the device 10.

The further key B is thus identifiable by the identification number allocated to the corresponding flash memory card and every device in the system which has the aforementioned features is individually characterized in the system. With the method described above, it can be guaranteed in respect of the password file stored on the flash memory card CF and encoded with the corresponding further key B and the associated identification number, that the individual password file of the respective device cannot be copied onto other devices which do not have the identification features (identification number and key).

Furthermore, usability of the thus encoded password file on other devices disposed in the distributed system can thereby be prevented.

The exemplary embodiments of the disclosure can also be implemented by at least one processor (e.g., general purpose or application specific) of a computer processing device which is configured to execute a computer program tangibly recorded on a non-transitory computer-readable recording medium, such as a hard disk drive, flash memory, optical memory or any other type of non-volatile memory. Upon executing the program, the at least one processor is configured to perform the operative functions of the above-described exemplary embodiments.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for configuring and distributing access rights among intelligent devices within a remotely monitored, distributed network control and station automation system of a utility supply system, wherein the distributed system includes at least a first intelligent device which is connected to further intelligent devices, via a network connection by a web client, and process and/or installation data provided from physically mutually remote parts of the utility supply system are transmitted to the intelligent devices, the method comprising:
storing a device-internal individual key and a shared key in each of the intelligent devices;
creating and configuring a user account in the first intelligent device via the web client as a password file,
individually encrypting the password file by a device-internal individual key of the first intelligent device and storing the individually encrypted password file in a memory module provided in the first intelligent device;
encrypting the password file by the shared key before reading the password file into the web client and making available the encrypted password file via the web client to the further intelligent devices;
distributing the encrypted password file by the web client via the network connection among the further intelligent devices;
decrypting the data stored in the encrypted password file in the further intelligent devices by the shared key; and
carrying out an individually encrypted storage of the password file with the previously decrypted data in a further respective intelligent device by a device-internal individual key of the respective intelligent device.

2. The method as claimed in claim 1, wherein the individually encrypted storage of the password file is carried out in each respective intelligent device with the device-internal individual key stored in the respective intelligent device.

3. The method as claimed in claim 1, wherein the shared key is understood by all of the intelligent devices.

4. The method as claimed in claim 1, wherein the shared key is understood only by intelligent devices of a similar device type.

5. The method as claimed in claim 4, comprising:
distributing the password file by the first intelligent device via the web client and the network connection among further devices of a similar intelligent device type disposed in the system.

6. The method as claimed in claim 1, comprising:
distributing the password file among the intelligent devices of the distributed system via the serial data transmission or via a TCP/IP protocol.

7. A device for configuring and distributing access rights among intelligent devices within a remotely monitored, distributed network control and station automation system of a utility supply system, process and/or installation data being provided from physically mutual remote parts of the utility supply system, comprising:
a first intelligent device;
a web client for creating and configuring a user account in the first intelligent device;
further intelligent devices connected to the at least one first intelligent device via a network connection of the web client, each of the first intelligent device and the further intelligent devices including a first memory module and a second memory module;
a first device-internal individual key stored in the second memory module of the first intelligent device for individually encrypting a password file of a user account, the second memory module storing the individually encrypted password file;
a shared key stored in the first memory module of the first intelligent device for encrypting data of the password file prior to reading into the web client, wherein the encrypted password file is distributed to the further intelligent devices via the web client through the network connection, and the shared key is stored in the further intelligent devices for decrypting the data stored in the encrypted password file; and
a further device-internal individual key of each respective further intelligent device for individually encrypting a password file containing previously decrypted data prior to its storage in the respective further intelligent device.

8. The device as claimed in claim 7, wherein the password file is distributable via the web client and the network connection among further intelligent devices of a similar device type disposed in the system.

9. The device as claimed in claim 7, wherein a user name, password and/or access rights are stored in the password file.

10. The device as claimed in claim 7, wherein the second memory module is a memory medium without moving parts, for example a Compact Flash memory card, and is permanently or directly integrated into the device.

11. The device as claimed in claim 7, comprising:
at least one decryption module; and
at least one encryption module;
wherein the second memory module is a Compact Flash memory card, and the second memory module is arranged to exchange data with the first memory module via the at least one decryption module and the at least one encryption module, and the device-internal individual key allocated to each intelligent device is provided to encrypt and decrypt the data transmitted from and to the first memory module.

12. The device as claimed in claim 11, comprising:
at least one further decryption module; and
at least one further encryption module;
wherein the first memory module is a RAM memory, wherein the first memory module exchanges data with the web client via the at least one further decryption module and the at least one further encryption module, and the shared key is provided to encrypt and decrypt the data transmitted from and to the web client.
